(19) United States
(12) Patent Application Publication
(10) Pub. No.: US 2015/0251491 A1
(43) Pub. Date: Sep. 10, 2015

(54) TIRE WITH TREAD FOR HIGH SEVERITY SERVICE

(71) Applicant: THE GOODYEAR TIRE & RUBBER COMPANY, Akron, OH (US)

(72) Inventors: Junling Zhao, Hudson, OH (US); Roberto Cerrato Meza, North Canton, OH (US); Austin Gale Young, Wadsworth, OH (US); Leandro Forciniti, Canton, OH (US)

(73) Assignee: THE GOODYEAR TIRE & RUBBER COMPANY, Akron, OH (US)

(21) Appl. No.: 14/200,180

(22) Filed: Mar. 7, 2014

(51) Int. Cl. B60C 1/00; B60C 11/00

(52) U.S. Cl. CPC B60C 1/0016; B60C 11/005; B60C 11/0008

(57) ABSTRACT

This invention relates to pneumatic rubber tires for high severity service, particularly a truck tire, having a circumferential tread of a cap/base configuration comprised of an outer tread cap rubber layer and an underlying tread base rubber layer wherein said tread cap rubber layer is comprised of a precipitated silica reinforced rubber comprised primarily of cis 1,4-polybutadiene rubber.

### FIELD OF THE INVENTION

This invention relates to pneumatic rubber tires for high severity service, particularly a truck tire, having a circumferential tread of a cap/base configuration comprised of an outer tread cap rubber layer and an underlying tread base rubber layer wherein said tread cap rubber layer is comprised of a precipitated silica reinforced rubber comprised primarily of cis 1,4-polybutadiene rubber.

### BACKGROUND OF THE INVENTION

Pneumatic rubber tires often have a tread of a cap/base construction composed of an outer tread cap rubber layer of a lug and groove configuration with the running surface of the tread and a tread base rubber layer which underlies the outer tread cap rubber layer to provide a transition to the tire carcass.

For pneumatic tires intended for high severity service such as truck tires, the outer tread cap rubber layer rubber composition may be composed of elastomers comprised primarily of natural cis 1,4-polyisoprene rubber with a minor amount of cis 1,4-polybutadiene rubber to promote resistance to tread wear for the tire. Such tire tread, namely its outer tread cap rubber layer, may be referred to as being natural rubber-rich.

Alternatively, tire treads for such heavy duty use have been suggested with an outer tread cap rubber layer being polybutadiene rubber rich as being comprised entirely of a specialized polybutadiene rubber or comprised primarily of a specialized cis 1,4-polybutadiene rubber composition and a minor amount of polyisoprene rubber and which contains reinforcing filler comprised of a combination of rubber reinforcing carbon black and precipitated silica such as, for example, from about 20 to about 60 phr of rubber reinforcing carbon black and about 10 to about 80 pr of precipitated silica. For example, see U.S. Pat. No. 8,445,580.

A challenge is presented for providing a pneumatic tire, for example a truck tire, for high severity service in a sense of carrying large loads which are subject to frequent vehicular starting, turning, braking and wheel torque application. For such tire tread, it is desired that, for its outer tread cap rubber layer, physical properties such as resistance to tread wear, relatively low hysteresis and resistance to tear are to be promoted while also promoting processability of the rubber composition in its uncured state.

In the description of this invention, terms such as “compounded rubber”, “rubber compound” and “compound”, if used herein, refer to rubber compositions containing of at least one elastomer blended with various ingredients, including curatives such as sulfur and cure accelerators. The terms “elastomer” and “rubber” may be used herein interchangeably unless otherwise indicated. It is believed that such terms are well known to those having skill in such art. Number and weight average molecular weights of an elastomer may be determined by, for example, by gel permeation chromatography (GPC) analytical equipment usually combined with a light scattering detector, a methodology known to those having skill in the polymer analytical art.

### Disclosure and Practice of the Invention

In accordance with this invention, a pneumatic rubber tire, particularly a truck tire, is provided having a circumferential rubber tread, particularly a truck tire, having a circumferential tread of a cap/base configuration comprised of an outer tread cap rubber layer and an underlying tread base rubber layer (underlying and joining the outer tread cap rubber layer as a transition between the outer tread cap rubber layer ant tire carcass) wherein said tread cap rubber layer is a silica-containing conjugated diene based rubber composition comprised of, based on parts by weight per 100 parts by weight of elastomer (phr),

(A) conjugated diene-based elastomers comprised of
(1) about 40 to about 80, alternately from at least 50 up to about 70, phr of cis 1,4-polybutadiene rubber, and
(2) about 60 to about 20, alternately from 30 up to 50, phr of at least one additional conjugated diene-based elastomer;

(B) about 40 to about 110, alternatively about 50 to about 80, phr of rubber reinforcing filler wherein said reinforcing filler is precipitated silica (synthetic amorphous silica) and from zero up to about 15, alternately from about 3 to about 10 and alternately from about 3 to about 6, phr of carbon black, if any, and

(C) silica coupling agent (for said precipitated silica) having a moiety reactive with hydroxyl groups (e.g. silanol groups) on said precipitated silica and another different moiety interactive with carbon-to-carbon double bonds of said conjugated diene-based elastomers.

In one embodiment, said precipitated silica and silica coupling agent may be provided individually in (to) the rubber composition individually and thereby react together in situ within the rubber composition or may be provided as a pre-reacted composite of said precipitated silica and silica coupling agent where the composite added to (or mixed with) the rubber composition.

In one embodiment, said additional conjugated diene-based elastomer may be comprised of at least one of polymer of at least one of isoprene and 1,3-butadiene and copolymer of styrene and at least one of isoprene and 1,3-butadiene.

Representative of such additional elastomers are, for example, cis 1,4-polyisoprene, styrene/isoprene, styrene/butadiene, and styrene/isoprene/butadiene elastomers.

In one embodiment, the cis 1,4-polybutadiene rubber is comprised of at least one of:

(A) a first specialized cis 1,4-polybutadiene rubber having a microstructure comprised of from about 90 to about 99 percent cis 1,4-isomeric units, a number average molecular weight (Mn) in a range of from about 120,000 to about 300,000 and a heterogeneity index (Mw/Mn) in a range of from about 2.1/1 to about 4.5/1 (a relatively high heterogeneity index range illustrating a significant disparity between its number average and weight average molecular weights), or

(B) a second specialized cis 1,4-polybutadiene rubber having a microstructure comprised of from about 93 to about 99 percent cis 1,4-isomeric units, a number average molecular weight (Mn) in a range of from about 150,000 to about 300,000 and a heterogeneity index (Mw/Mn) in a range of from about 1.5/1 to about 2/1 (a relatively moderate heterogeneity index range illustrating a moderate disparity between its number average and weight average molecular weights).

In one embodiment, the underlying tread base rubber layer may be of a rubber composition comprised of, for example, at least one conjugated diene-based elastomer and reinforcing filler comprised of rubber reinforcing carbon black and, optionally, precipitated silica.

In one embodiment, said carbon black is provided as a composite of said silica coupling agent with rubber reinforcing carbon black as a carrier for the silica coupling agent and thereby therefore exclusive of any significant addition, if any, of a freely added rubber reinforcing carbon black to said rubber composition.

In one embodiment, said first specialized cis 1,4-polybutadiene rubber may be the product of a nickel or cobalt catalyst promoted polymerization of 1,3-butadiene monomer in an organic solvent solution. For example, U.S. Pat. No. 5,451,646 illustrates nickel catalyzed polymerization of 1,3-butadiene monomer with a catalyst system comprised of, for example, a combination of an organonickel compound (e.g. nickel salt of a carboxylic acid), organoaluminum compound (e.g. trialkylaluminum) and fluoride containing compound (e.g. hydrogen fluoride or complex thereof).

Representative of said first specialized cis 1,4-polybutadiene elastomer is, for example, Budene 1207™ from The Goodyear Tire & Rubber Company.

In one embodiment, said second specialized cis 1,4-polybutadiene rubber may be the product of a neodymium or titanium catalyst promoted polymerization of 1,3-butadiene monomer in an organic solvent. For example, 1,3-butadiene monomer may be polymerized in an organic solvent solution in the presence of a catalyst system comprised of, for example, organoaluminum compound, organometallic compound such as for example neodymium and labile (e.g. vinyl) halide described in, for example and not intended to be limiting, U.S. Pat. No. 4,663,405 for the neodymium catalyzed polymerization.

Representative of neodymium compounds might be, for example, neodymium neodecanoate, neodymium octanoate or neodymium versalate. The neodymium compounds might be derived from a neodymium carboxylate soap such as, for example Nd(R-C00)₃. Representative of aluminum alkyl compounds may be, for example, triisobutylaluminum (TIBA) and diisobutylaluminum hydride (DIBAH). Representative of aluminum chloride delivering compounds may be, for example, diethylaluminum chloride, all so long as the specialized polybutadiene elastomer possesses the aforesaid microstructure, molecular weight and heterogeneity index and Tg ranges.

Therefore, the catalyst for preparation of said second specialized polybutadiene elastomer is exclusive of cobalt or nickel based catalysts used for preparation of cis 1,4-polybutadiene elastomers.

A purpose for the use of the second specialized polybutadiene may be to promote higher rebound values for the rubber composition which is predictive of less internal heat generation, and therefore less temperature build-up for the rubber composition when it is being worked and predictive of better (lower) rolling resistance for a tire with a tread of such rubber composition which contains the specialized polybutadiene rubber. A further purpose is to promote greater abrasion resistance of the rubber composition which is predictive of better resistance to tread wear for a tire with such rubber composition in which the polybutadiene elastomer is the second specialized polybutadiene elastomer.

Representative of said second specialized cis 1,4-polybutadiene elastomer for use in this invention as 1,3-butadiene polymerized with a neodymium based catalysis is, for example, CB25™ Budene from Lanxess.

In one embodiment, the polymer chain of the second specialized polybutadiene elastomer might be coupled (coupled to itself to thereby increase its molecular weight or to promote branching of the elastomer, namely branching of its polymer chain), for example, by treatment with, for example, a sulfur chloride such as, for example, disulfur dichloride as mentioned in U.S. Pat. No. 5,567,784 as would be known to those having skill in such art.

The silica coupling agent for the precipitated silica may be comprised of, for example, a bis(3-trialkoxysilylalkyl) polysulfide containing an average in a range of from about 2 to about 3.8, alternately from about 2 to about 2.6 and alternately from about 3 to about 3.8, connecting sulfur atoms in its polysulfidic bridge or an alkoxyorganomercaptosilane.

In one embodiment, said silica coupling agent is said bis(3-trialkoxysilylalkyl) polysulfide comprised of a bis(3-triethoxysilylpropyl) polysulfide.

In one embodiment said bis(3-triethoxypropyl) polysulfide silica coupling agent contains an average in a range of from about 2 to about 2.6 connecting sulfur atoms in its polysulfidic bridge. Such silica coupling agent with a polysulfidic content to an average of from about 2 to 2.6 connecting sulfur atoms may be particularly useful to promote ease of processing, including mixing, extruding and calendering, the uncured rubber composition.

Providing the reinforcing filler as being primarily composed of precipitated silica, with only a minimal and relatively non-elastomer reinforcing amount of carbon black which may be, for example, a small amount, if any, which might used as a carrier for a silica coupling agent for the precipitated silica and therefore preferably without, or with only a minimal amount (e.g. cosmetic amount and therefore less than a significant rubber reinforcing amount) of freely added carbon black to the rubber composition.

The precipitated silica reinforcement (precipitated silica) for the rubber composition is a synthetic amorphous silica such as, for example, obtained by the acidification of a soluble silicate (e.g. sodium silicate or a co-precipitation of a silicate and an aluminate). Such precipitated silicas are, in general, well known to those having skill in such art.

The BET surface area of the synthetic silica (precipitated silica), as measured using nitrogen gas, may, for example, be in a range of about 50 to about 300, alternatively about 120 to about 200, square meters per gram which may be determined by, for example, the Brauner-Emmitt-Kelly method which may be reviewed, for example, in American Chemical Society, v. 60 (1938) Page 309.

The silica may also have, for example, a dibutylphthalate (DBP) absorption value in a range of, for example, about 100 to about 400, and usually about 150 to about 300 cc/g.

Various commercially available synthetic silicas, particularly precipitated silicas, may be considered for use in this invention such as, for example, only and without limitation, silicas commercially available from PPG Industries under the Hi-Sil trademark with designations 210, 243, etc; silicas from Rhodia, with designations of Zeosil 1165MP™ and Zeosil Premium 200™ and silicas from Evonic as VN2™ and VN3™, 3770GR™, and from Huber as Zeopol 8745™.

The silica reinforcement for the rubber tire tread is used with a silica coupling agent as hereinbefore discussed. As indicated, such silica coupling agent, for example, may be premixed, or pre-reacted, with the precipitated silica. As hereinbefore indicated, in one embodiment said precipitated silica and silica coupling agent may be provided as a pre-reacted composite of said precipitated silica and silica coupling agent.

Therefore, the precipitated silica may be provided as a composite of precipitated silica pre-treated with the silica coupling agent and the composite thereby added to the rubber composition.

Alternately, the precipitated silica and silica coupling agent may be provided individually (e.g. separately) to the rubber composition and the precipitated silica and silica coupling agent thereby allowed to react together in situ within the rubber composition.

The composite of precipitated silica pre-treated with a silica coupling may be sometimes referred to as a chemically treated precipitated silica, or “CTS”.

Such coupling agent for the CTS may be comprised of, for example, at least one of bis(3-alkoxysilylalkyl) polysulfide having an average of from about 2 to about 4 connecting sulfur atoms in its polysulfidic bridge (e.g. a bis(3-triethoxysilylpropyl) polysulfide) and alkoxyorganomercaptosilane.

As indicated above, if the silica coupling agent and precipitated silica are added separately to the rubber mix during the rubber/silica mixing, or processing stage, it is considered that the silica coupling agent then combines (reacts) in situ with the precipitated silica.

For this invention, it is desired that the sulfur cured rubber composition for the tire tread based upon the precipitated silica reinforcement-containing rubber composition which contains the specialized cis 1,4-polybutadiene rubber has physical properties presented in the following Table A.

TABLE A

| | |
|---|---|
| Tear resistance, 95° C., of the cured rubber, | at least 130 |
| (DIN 53539, Newtons) of | |
| Dynamic storage modulus G’, 100° C, | less than 260 |
| of the uncured rubber (KPa) of | |
| Grosch abrasion rate (high severity), | less than 800, |
| mg/km, of the cured rubber of | preferably less than 600 |
| Heterogeneity index of the specialized | from 1.5/1 to about 2.1/1 |
| cis 1,4-polybutadiene | |
| An aged tear resistance, 95° C. (Newtons) | at least 100 |
| may also be desired,of (aged 7 day at 70° C. | |
| at atmospheric conditions | |

The original and aged tear resistances may be administered and reported, for example, by ASTM D1876-1 taken with DIN 53539 using a 5 mm wide tear width provided by a longitudinal open space, sometimes referred to as a window, cut or otherwise provided, in the film positioned between the two rubber test pieces where the window provides a geometrically defined area, namely the tear width, for portions of two rubber test pieces to be pressed and cured together after which the force to pull the test pieces apart is measured.

It is readily understood by those having skill in the art that the rubber compositions of the tread would be compounded with conventional compounding ingredients including the aforesaid reinforcing fillers such as carbon black and precipitated silica, as hereinbefore defined, in combination with a silica coupling agent, as well as antidegradant(s), processing oil as hereinbefore defined, fatty acid comprised of, for example, stearic, oleic, palmitic, and possibly linolenic, acids, zinc oxide, sulfur-contributing material(s) and vulcanization accelerator(s) as hereinbefore mentioned.

Processing aids may be used, for example, waxes such as microcrystalline and paraffinic waxes, in a range, for example, of about 1 to 5 phr or about 1 to about 3 phr; and resins, usually as tackifiers, such as, for example, synthetic hydrocarbon and natural resins in a range of, for example, about 1 to 5 phr or about 1 to about 3 phr. A curative might be classified as sulfur together with one or more sulfur cure accelerator(s). In a sulfur and accelerator(s) curative, the amount of sulfur used may be, for example, from about 0.5 to about 5 phr, more usually in a range of about 0.5 to about 3 phr; and the accelerator(s), often of the sulfenamide type, is (are) used in a range of about 0.5 to about 5 phr, often in a range of about 1 to about 2 phr. The ingredients, including the elastomers but exclusive of sulfur and accelerator curatives, are normally first mixed together in a series of at least two sequential mixing stages, although sometimes one mixing stage might be used, to a temperature in a range of, for example, about 145° C. to about 185° C., and such mixing stages are typically referred to as non-productive mixing stages. Thereafter, the sulfur and accelerators, and possibly one or more retarders and possibly one or more antidegradants, are mixed therewith to a temperature of, for example, about 90° C. to about 120° C. and is typically referred as a productive mix stage. Such mixing procedure is well known to those having skill in such art.

After mixing, the compounded rubber can be fabricated such as, for example, by extrusion through a suitable die to form a tire tread. The tire tread is then typically built onto a sulfur curable tire carcass and the assembly thereof cured in a suitable mold under conditions of elevated temperature and pressure by methods well known to those having skill in such art.

The invention may be better understood by reference to the following example in which the parts and percentages are by weight unless otherwise indicated.

### EXAMPLE I

Rubber compositions were prepared to evaluate their use as a tread rubber for a truck tire intended for the aforesaid high severity service.

Rubber compositions are referred in this Example as Control rubber Sample A and Experimental rubber Samples B through D.

Rubber Sample A is a Comparative Sample based on natural rubber and cis 1,4-polybutadiene rubber with carbon black reinforcing filler.

Experimental rubber Samples B, C and D are Experimental rubber Samples based on a combination of natural cis 1,4-polyisoprene rubber and increasing amounts of specialized cis 1,4-polybutadiene rubber with precipitated silica reinforcement and minimal amount of rubber reinforcing carbon black contained only in the silica coupler composite as a carrier for the coupling agent, with no freely added carbon black for the rubber composition, and therefore considered to be only a cosmetic amount of carbon black.

The basic rubber composition formulation is shown in Table 1 and the ingredients are expressed in parts by weight per 100 parts rubber (phr) unless otherwise indicated.

The rubber compositions may be prepared by mixing the elastomers(s) without sulfur and sulfur cure accelerators in a non-productive mixing stage (NP) in an internal rubber mixer for about 4 minutes to a temperature of about 160° C. If desired, the rubber mixture may then mixed in a second non-productive mixing stage (NP-2) in an internal rubber mixer for about 4 minutes to a temperature of about 160° C. without adding additional ingredients. The resulting rubber mixture may then mixed in a productive mixing stage (PR) in an internal rubber mixer with sulfur and sulfur cure accelerator(s) for about 2 minutes to a temperature of about 110° C. The rubber composition may then sheeted out and cooled to below 50° C. between each of the non-productive mixing steps and prior to the productive mixing step. Such rubber mixing procedure is well known to those having skill in such art.

TABLE 1

| First Non-Productive Mixing | Parts (phr) | |
|---|---|---|
| Step (NP1) Experimental | Control | |
| Natural cis 1,4-polyisoprene rubber (TTR20) | 50 | 20 to 40 |
| Cis 1,4-polybutadiene rubber¹ | 0 | 60 to 80 |
| Cis 1,4-polybutadiene rubber2 | 25 | 0 |
| S-SBR rubber³ | 25 | 0 |
| Carbon black, freely added (N220) | 55 | 0 |
| Silica, precipitated⁴ | 0 | 50 |
| Silica coupling agent 50/50 | 0 | 12 |
| carbon black composite⁵ | | |
| Oil, rubber processing⁶ | 5 | 3 |
| Wax microcrystalline and paraffin | 1.5 | 1.5 |
| Fatty acid⁷ | 2.5 | 2 |
| Antioxidants | 3 | 3.5 |
| Zinc oxide | 3 | 3 |
| Productive Mixing Step (PR) | | |
| Sulfur | 1 | 1.65 |
| Accelerator(s)⁸ | 1.1 | 1.75 |

¹Cis 1,4-polybutadiene rubber (said organic solvent solution polymerized 1,3-butadiene monomer in the presence of a neodymium catalyst) as CB25 ™ from the Lanxess Company having a Tg of about −105° C. and heterogeneity index in a range of from about 1.5/1 to about 2.2/1
2Cis 1,4-polybutadiene rubber as Budene 1207 ™ from The Goodyear Tire & Rubber Company
³Solution polymerization prepared styrene/butadiene rubber as SLF18B10 ™ from The Goodyear Tire & Rubber Company
⁴Precipitated silica as Zeosil ™ Z1165 MP from the Rhodia Company
⁵This is a composite of silica coupling agent and carbon black (carrier) in a 50/50 weight ratio where said coupling agent is comprised of bis(3-triethoxysilylpropyl) polysulfide having an average of from about 2 to about 2.6 connecting sulfur atoms in its polysulfidic bridge as Si266 ™ from Evonic. Therefore, the composite is comprised of 50 percent, or 6 phr, of rubber reinforcing carbon black.
⁶Rubber processing oil
⁷Mixture comprised of stearic, palmitic and oleic acids
⁸Sulfenamide and diphenyl guanidine sulfur cure accelerators and retarder as needed for scorch safety

The following Table 2 represents the uncured and cured behavior and various physical properties of the rubber compositions based upon the basic formulation of Table 1, and reported for Control rubber Sample A and Experimental rubber Samples B through D.

TABLE 2

| | Control | Experimental | | |
|---|---|---|---|---|
| | A | B | C | D |
| Natural rubber —TTR-20 (phr) | 50 | 40 | 30 | 20 |
| Cis 1,4-polybutadiene rubber (phr)¹ | 0 | 60 | 70 | 80 |
| Cis 1,4-polybutadiene rubber (phr)² | 25 | 0 | 0 | 0 |
| S-SBR rubber³ | 25 | 0 | 0 | 0 |
| Carbon black (N220) | 55 | 0 | 0 | 0 |
| Silica, precipitated⁴ | 0 | 50 | 50 | 50 |
| Silica coupling agent composite⁵ | 0 | 12 | 12 | 12 |
| Properties | | | | |
| RPA test uncured dynamic | 210 | 199 | 201 | 205 |
| storage modulus G’ (KPa) | | | | |
| At 10% strain, 1 Hertz, 100° C. | | | | |
| Dynamic storage modulus G (MPa) | 1.13 | 1.83 | 1.91 | 2.05 |
| Tan delta | 0.22 | 0.09 | 0.09 | 0.09 |
| MDR test; 60 minutes at 150° C | | | | |
| Maximum torque (dN-m) | 17.7 | 23.8 | 24.8 | 25.9 |
| Minimum torque (dN-m) | 3.33 | 2.6 | 2.6 | 2.7 |
| T90 (minutes) | 13.7 | 18.0 | 18.6 | 17.7 |
| Stress-strain | | | | |
| Tensile strength (MPa) | 21 | 19 | 16 | 17 |
| Elongation at break (%) | 581 | 536 | 468 | 466 |
| 100% modulus, ring, (MPa) | 2.0 | 2.3 | 2.3 | 2.4 |
| 300% modulus, ring, (MPa) | 9.1 | 9.5 | 9.4 | 9.8 |
| Rebound (Zwick) | | | | |
| 23° C. | 42 | 60 | 60 | 62 |
| 100° C. | 56 | 68 | 68 | 69 |
| Shore A Hardness | | | | |
| 23° C. | 66 | 66 | 67 | 69 |
| 100° C. | 55 | 63 | 63 | 64 |
| Tear Strength (tear resistance)¹, N | | | | |
| At 23° C. | 221 | 120 | 128 | 128 |
| At 95° C. | 145 | 100 | 106 | 110 |
| Aged 7 Days at70° C., tested at 95° C. | 127 | 68 | 57 | 63 |
| Abrasion rate (mg/km), Grosch² | | | | |
| Medium severity (40 N), 6° slip angle, | | | | |
| disk speed = 20 km/hr, | 75 | 77 | 75 | 72 |
| distance = 1,000 meters | | | | |
| High severity (70 N), 12° slip angle, disk | | | | |
| speed =20 km/hr, distance = 250 meters | 570 | 748 | 649 | 537 |
| Ultra high severity (70 N), 16° slip angle, | | | | |
| disk speed =20 km/hr, | 1150 | 1349 | 1140 | 873 |
| distance = 500 meters | | | | |

¹Data obtained according to a tear strength (peal adhesion), or tear resistance test. As previously indicated, the tear resistance may be administered and reported, for example, by ASTM D1876-01 taken with DIN 53539 using a 5 mm wide tear width provided by a longitudinal open space, sometimes referred to as a window, cut or otherwise provided, in the film positioned between the two rubber test pieces where the window provides a geometrically defined area, namely tear width, for portions of two rubber test pieces to be pressed and cured together after which the ends of the two test pieces are pulled apart at right angles (90° + 90° = 180°) and the force to pull the test pieces apart is measured. An Instron instrument may be used to pull the rubber pieces apart and measure the force, usually in Newtons.
²The Grosch abrasion rate run on an LAT-100 Abrader and is measured in terms of mg/km of rubber abraded away. The test rubber sample is placed at a slip angle under constant load (Newtons) as it traverses a given distance on a rotating abrasive disk (disk from HB Schleifmittel GmbH). In practice, a low abrasion severity test may be run, for example, at a load of 20 Newtons, 2° slip angle, disk speed of 40 km/hr for a distance of 7,500 meters; a medium abrasion severity test may be run, for example, at a load of 40 Newtons, 6° slip
angle, disk speed of 20 km/hr and distance of 1,000 meters; a high abrasion severity test may be run, for example, at a load of 70 Newtons, 12° slip angle, disk speed of 20 km/hr and distance of 250 meters; and an ultra high abrasion severity test may be run, for example, at a load of 70 Newtons, 16° slip angle, disk speed of 20 km/hr and distance of 500 meters.

It is seen in Table 2 that all of Experimental rubber Samples B, C and D fulfilled the target physical values presented in Table A.

In particular, it is seen in Table 2 that as the polybutadiene rubber content is increased, the Grosch abrasion rate is reduced at all levels as seen by Experimental rubber Samples B, C and D, as compared to Control rubber Sample A and particularly for the ultra high severity Grosch abrasion rate of Experimental rubber Sample B which used 60 phr of the polybutadiene rubber.

This is considered as being significant in a sense that the reduction in the abrasion rate is indicative of a greater resistance to tread wear for a tire tread.

It is also seen in Table 2 that as the polybutadiene rubber content is increased the stiffness of the rubber composition is significantly increased as illustrated by an increase in both of the Shore A and G′ modulus physical properties of Experimental rubber Samples B, C and D with Rubber Sample D containing a beneficial level of 60 phr of the polybutadiene rubber.

This is considered as being significant in a sense that such increase in physical properties are indicative of increased tire tread durability such as, for example, tread wear resistance.

### EXAMPLE II

Additional rubber compositions were prepared to evaluate their use as a tread rubber for a truck tire intended for the aforesaid use as high severity service. For this Example II, 60 parts by weight (phr) of the polybutadiene elastomer are to be used based on the aforesaid beneficial usage of 60 phr of the polybutadiene elastomer illustrated in Example I.

Rubber compositions are referred in this Example as Control rubber Sample A (of Example I) and Experimental rubber Samples E and F.

As in Example I, rubber Sample A is a Comparative Sample based on natural rubber and cis 1,4-polybutadiene rubber with carbon black reinforcing filler.

Experimental rubber Samples E through I are Experimental rubber Samples based on a combination of natural cis 1,4-polyisoprene rubber and 60 parts by weight specialized cis 1,4-polybutadiene rubber with precipitated silica reinforcement and minimal amount of rubber reinforcing carbon black contained only in the silica coupler composite as a carrier for the silica coupler and therefore considered to only contain a cosmetic amount of carbon black and without freely added rubber reinforcing carbon black being used in the rubber compositions.

The basic rubber composition formulation is shown in Table 3 and the ingredients are expressed in parts by weight per 100 parts rubber (phr) unless otherwise indicated.

The rubber compositions may be prepared in the manner as Example I.

TABLE 3

| First Non-Productive | Parts (phr) | |
|---|---|---|
| Mixing Step (NP1) | Control | Experimental |
| Natural cis 1,4-polyisoprene rubber (TTR20) | 50 | 40 |
| Specialized cis 1,4-polybutadiene rubber | 0 | 60 |
| Cis 1,4-polybutadiene rubber² | 25 | 0 |
| S-SBR rubber³ | 25 | 0 |
| Carbon black, freely added (N220) | 55 | 0 |
| Silica, precipitated⁴ | 0 | 50 |
| Silica coupling agent 50/50 | 0 | 11, 12 |
| carbon black composite⁵ | | |
| Oil, rubber processing⁶ | 5 | 0, 5 |
| Wax microcrystalline and paraffin | 1.5 | 1.5 |
| Fatty acid⁷ | 2.5 | 2 |
| Antioxidants | 3 | 3.5, 4 |
| Zinc oxide | 3 | 3 |
| Productive Mixing Step (PR) | | |
| Sulfur | 1 | 0.9, 1, 1.2 |
| Accelerator(s)⁸ | 1.1 | 1.55 |

¹Cis 1,4-polybutadiene rubber (said organic solvent solution polymerized 1,3-butadiene monomer in the presence of a neodymium catalyst) as CB25 ™ from the Lanxess Company having a Tg of about −105° C. and heterogeneity index in a range of from about 1.5/1 to about 2.2/1
²Cis 1,4-polybutadiene rubber as Bud1207 ™ from The Goodyear Tire & Rubber Company prepared by nickel catalyzed 1,3-butadiene monomer (The aforesaid first polybutadiene)
³Solution polymerization prepared styrene/butadiene rubber as SLF18B10 ™ from The Goodyear Tire & Rubber Company
⁴Precipitated silica as Zeosil ™ Z1165 MP from the Rhodia Company
⁵This is a composite of silica coupling agent and carbon black (carrier) in a 50/50 weight ratio where said coupling agent is comprised of bis(3-triethoxysilylpropyl) polysulfide having an average of from about 2 to about 2.6 connecting sulfur atoms in its polysulfidic bridge as Si266 ™ from Evonic. Therefore, 50 percent of the composites contain 5.5 and 6 phr, respectively, of rubber reinforcing black.
⁶Rubber processing oil
⁷Mixture comprised of stearic, palmitic and oleic acids
⁸Sulfenamide and diphenyl guanidine sulfur cure accelerators with a retarder as needed for scorch safety.

The following Table 4 represents the uncured and cured behavior and various physical properties of the rubber compositions based upon the basic formulation of Table 3, and reported as Control rubber Sample A and Experimental rubber Samples E and F.

TABLE 4

| | Control | Experimental | |
|---|---|---|---|
| | A | E | F |
| Natural rubber TTR-20 (phr) | 50 | 40 | 40 |
| Specialized cis 1,4-polybutadiene rubber (phr)¹ | 0 | 60 | 60 |
| Cis 1,4-polybutadiene rubber (phr)² | 25 | 0 | 0 |
| S-SBR rubber³ | 25 | 0 | 0 |
| Carbon black, freely added (N220) | 55 | 0 | 0 |
| Silica, precipitated⁴ | 0 | 50 | 50 |
| Silica coupling agent (carbon black composite)⁵ | 0 | 11 | 12 |
| Oil⁶ | 5 | 0 | 0 |
| Sulfur | 1 | 1 | 0.9 |
| Accelerator(s)⁸ | 1.1 | 0 | 0 |
| Properties | | | |
| RPA test uncured dynamic | 210 | 300 | 290 |
| storage modulus G’ (KPa) | | | |
| At 10% strain, 1 Hertz, 100° C. | | | |
| Dynamic storage modulus G’ (MPa) | 1.13 | 1.57 | 1.52 |
| Tan delta | 0.22 | 0.12 | 0.12 |
| MDR test; 60 minutes at 150° C. | | | |
| Maximum torque (dN-m) | 17.7 | 20.6 | 20.4 |
| Minimum torque (dN-m) | 3.33 | 3.83 | 3.66 |
| T90 (minutes) | 13.7 | 23.7 | 22.9 |
| Stress-strain | | | |
| Tensile strength (MPa) | 21 | 20 | 20 |
| Elongation at break (%) | 581 | 624 | 567 |
| 300% modulus, ring, (MPa) | 9.1 | 8.0 | 9.2 |
| Rebound (Zwick) | | | |
| 23° C. | 42 | 55 | 55 |
| 100° C. | 56 | 63 | 64 |
| Shore A Hardness | | | |
| 23° C. | 66 | 67 | 68 |
| 100° C. | 55 | 59 | 60 |
| Tear Strength (tear resistance)¹, N | | | |
| At 23° C. | 221 | 253 | 205 |
| At 95° C. | 145 | 190 | 164 |
| Aged 7 Days at 70° C., tested at 95° C. | 127 | 126 | 113 |
| Abrasion rate (mg/km), Grosch² | | | |
| Medium severity (40N), | 75 | 65 | 63 |
| 6° slip angle, disk speed = | | | |
| 20 km/hr, distance = 1,000 meters | | | |
| High severity (70N), | 570 | 452 | 440 |
| 12° slip angle, disk speed = | | | |
| 20 km/hr, distance = 250 meters | | | |
| Ultra high severity (70N), | 1150 | 876 | 818 |
| 16° slip angle, disk speed = | | | |
| 20 km/hr, distance = 500 meters | | | |

The test procedures are those used in Example I.

It is seen in Table 4 that all of the Experimental rubber Samples E and F which contain the specialized polybutadiene rubber and precipitated silica reinforcing filler with the only carbon black being a low level as a carrier for the silica coupler have beneficially lower Grosch abrasion rates than Control rubber Sample A. Thus the reinforcing filler is the precipitated silica with the carbon black content being less than a reinforcing amount and therefore in a nature of a cosmetic amount to impart a black color to the rubber composition with the utility of the carbon black being a carrier for the silica coupler.

The lower abrasion rates are considered as being significant in a sense that it is indicative of greater resistance to tread wear for a tire tread with ground contacting tread of such rubber compositions.

It is also seen in Table 4 that significantly and beneficially increased rebound values as well as beneficially reduced Tan Delta values are observed for Experimental rubber Samples E and F which contained the specialized polybutadiene and precipitated silica, with the minimal carbon black contend as a carrier for the silica coupling agent, as compared to Control rubber Sample A.

It is further seen in Table 4 that all of the Experimental rubber Samples E and F exhibited tear strength (resistance to tear) similar to Control rubber Sample A.

This is considered as being significant in a sense that the Experimental rubber Samples E and F and Control rubber Sample A have similar tear resistance values.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic rubber tire with a circumferential rubber tread having a cap/base configuration comprised of an outer tread cap rubber layer and an underlying tread base rubber layer wherein said tread cap rubber layer is a silica-containing conjugated diene based rubber composition comprised of, based on parts by weight per 100 parts by weight of elastomer (phr),
(A) conjugated diene-based elastomers comprised of
(1) about 40 to about 80 phr of cis 1,4-polybutadiene rubber, and
(2) about 60 to about 20 phr of at least one additional diene-based elastomer;
(B) about 40 to about 110 phr of reinforcing filler wherein said reinforcing filler is precipitated silica and from zero up to about 15 phr of carbon black, and
(C) silica coupling agent having a moiety reactive with hydroxyl groups on said precipitated silica and another different moiety interactive with carbon-to-carbon double bonds of said conjugated diene-based elastomers.

2. The tire of claim 1 wherein said rubber composition contains from about 3 to about 10 phr of carbon black as a carrier for said coupling agent without freely added carbon black.

3. The tire of claim 1 wherein said additional conjugated diene-based elastomer is comprised of at least one of polymers of at least one of isoprene and 1,3-butadiene and copolymers of styrene and at least one of isoprene and 1,3-butadiene.

4. The tire of claim 1 wherein said additional conjugated diene-based elastomer is comprised of at least one of cis 1,4-polyisoprene and styrene/butadiene elastomers.

5. The tire of rubber composition of claim 1 wherein said cis 1,4-polybutadiene rubber is comprised of at least one of:
(A) a first specialized cis 1,4-polybutadiene rubber having a microstructure comprised of from about 90 to about 99 percent cis 1,4-isomeric units, a number average molecular weight (Mn) in a range of from about 120,000 to about 300,000 and a heterogeneity index (Mw/Mn) in a range of from about 2.1/1 to about 4.5/1, or
(B) a second specialized cis 1,4-polybutadiene rubber having a microstructure comprised of from about 93 to about 99 percent cis 1,4-isomeric units, a number average molecular weight (Mn) in a range of from about 150,000 to about 300,000 and a heterogeneity index (Mw/Mn) in a range of from about 1.5/1 to about 2/1.

6. The tire of claim 1 wherein said coupling agent is comprised of a bis (3-trialkoxysilylalkyl) polysulfide having an average of from 2 to 4 connecting sulfur atoms in its polysulfidic bridge or alkoxyorganomercapto silane.

7. The tire of claim 1 wherein said precipitated silica is a composite of precipitated silica and coupling agent comprised of at least one of bis (3-trialkoxysilylalkyl) polysulfide having an average of from 2 to 4 connecting sulfur atoms in its polysulfidic bridge and alkoxyorganomercaptosilane.

8. The tire of claim 1 wherein said coupling agent is comprised of a bis(3-triethoxysilylpropyl) polysulfide having an average of from about 2 to about 2.6 connecting sulfur atoms in its polysulfidic bridge.

9. The tire of claim 1 wherein said coupling agent is comprised of a bis(3-triethoxysilylpropyl) polysulfide having an average of from about 3.4 to about 3.8, connecting sulfur atoms in its polysulfidic bridge.

10. The tire of claim 1 wherein said coupling agent is comprised of an alkoxyorganomercaptosilane.

11. The tire of claim 1 wherein said precipitated silica and silica coupling agent are individually provided in the rubber composition

12. The tire of claim 1 wherein said precipitated silica and silica coupling agent are provided as a pre-reacted composite of said precipitated silica and silica coupling agent.

13. The tire of claim 1 wherein said specialized polybutadiene elastomer is a neodymium catalyst prepared polybutadiene prepared by polymerization of 1,3-polybutadiene monomer in an organic solvent solution in the presence of a catalyst system comprised of neodymium compound, an aluminum alkyl and an aluminum chloride delivering compound, and by coupling the polybutadiene by treating the reaction mixture with disulfur dichloride so long as the said specialized polybutadiene possesses the aforesaid microstructure, molecular weight and heterogeneity index.

14. The tire of claim 13 wherein said neodymium compound is comprised of neodymium neodecanoate, neodymium octanoate or neodymium versalate; the aluminum alkyl compound is comprised of triisobutylaluminum or diisobutylaluminum hydride and the aluminum chloride delivering compound is comprised of diethylaluminum chloride, so long as the specialized polybutadiene elastomer possesses the aforesaid microstructure, molecular weight and heterogeneity index and Tg ranges.

15. The tire of claim 13 wherein the catalyst for preparation of said specialized polybutadiene elastomer is exclusive of titanium, cobalt and nickel based catalysts.

16. The tire of claim 13 wherein said specialized polybutadiene contains branching promoted by treatment with said disulfur dichloride.
